(19) United States
(12) Patent Application Publication
(10) Pub. No.: US 2014/0202864 A1
(43) Pub. Date: Jul. 24, 2014

(54) FUEL MAGNETIZATION TREATMENT METHOD

(71) Applicants: Manabu Hasegawa, Tokyo (JP); Shinpei Fukamachi, Kitamoto City (JP)

(72) Inventors: Manabu Hasegawa, Tokyo (JP); Shinpei Fukamachi, Kitamoto City (JP)

(73) Assignee: Zhenjiang Keyue Ene-Tech Co., Ltd., Zhenjiang New Area Zhenjiang (CN)

(21) Appl. No.: 13/880,748

(22) PCT Filed: Oct. 17, 2011
(86) PCT No.: PCT/CN2011/080861

§ 371 Date: Mar. 13, 2014

(30) Foreign Application Priority Data
Oct. 22, 2010 (CN) 201010516574.6

(51) Int. Cl. F02M 27/04

(52) U.S. Cl. CPC F02M 27/04
USPC 204/557

(57) ABSTRACT

A fuel magnetization treatment method includes mounting electromagnetic coils on a supply system through which fuel is supplied to a combustion device of an engine (7), connecting two joints of the electromagnetic coils with an electromagnetic generating device, and providing alternating current to the electromagnetic coils through the electromagnetic generating device so that an alternating current magnetic field is generated by the electromagnetic coils and is used to magnetize the fuel in the engine, where the frequency zone of the alternating current is 4 kHz˜25 kHz. The method can improve the combustion efficiency of various fuels, enhance the power output performance of the engine, inhibit the emission of various pollution gases and prolong the life of engine lubricating oil.

### TECHNICAL FIELD

This invention is related to the fuel processing technology, in particularly a magnetic processing method for fuels.

### BACKGROUND

The current typical technical theory of e.g. a four-stroke engine has four strokes in every combusting cycle.
1. INTAKE stroke: The piston descends from the top of the cylinder to the bottom of the cylinder→A mixture of fuel and air, (Or just air in a diesel engine), is forced by atmospheric (or greater) pressure into the cylinder through the intake port→The intake valve(s) then closes.
2. COMPRESSION stroke: With both intake and exhaust valves closed→the piston returns to the top-dead-point, compressing the air or fuel-air mixture into the combustion chamber of the cylinder head→The temperature of the air or fuel-air mixture rises by several hundred degrees during the compression stroke.
3. POWER stroke: While the piston is close to top of the cylinder, the compressed air-fuel mixture in a gasoline engine is ignited; in a diesel engine, diesel fuel is injected into the cylinders, which ignites due to the heat generated in the air during the compression stroke→The resulting pressure from the combustion of the compressed fuel-air mixture forces the piston back down toward bottom-dead-point. The forces of moving pistons drive the crankshaft and provide energy to move vehicles or ships.
4. EXHAUST stroke: during the exhaust stroke, the piston once again returns to top-dead-point while the exhaust valve is open. This action expels the spent fuel-air mixture exhaust gas (includes CO2, NOx, SOx, HC, CO etc.) through the exhaust valves. The exhaust gases must be cleaned by passing through the filters or other processing equipment→released to the air.

The drawbacks of fuel supply systems of the modern internal-combustion-engine:
1. Most of the modern engines are optimizing its efficiency via modifying mechanic designs and improving its fuel injection and fuel management computer systems and sensors technologies to adjust a better air-fuel-ratio or accurate fuel injection ration and timing. The performances of the engines almost have reached their limitation.
2. To use noble metal type catalysts and ceramics filters to process and neutralize the harmful emissions in the exhaust gas.

Although the above technologies have been improved a lot, there still a technical bottle-neck that they cannot really perfectly solve the incomplete combustion fuels in every “power-stroke”, the current technologies can only process the harmful combustible fuel residues by burning them of oxidize them. All these methods are costly and cannot prevent the wastage of fuels. We also need to know that the incomplete combustion produce the most harmful emissions to and force us to ‘clean them’ costly.

The main emissions of an internal-combustion-engine are:
A. Harmful materials oxidations:
   Nitrogen oxides (NOx) & Sulfur oxide (SOx): these two oxidations generated when nitrogen in the air (or sulfurs in the fuels) reacts with oxygen at the high temperature and pressure inside the engine. They can cause precursor to smog and acid rain.
B. Toxic Gases: Carbon monoxide (CO) & Hydrocarbons (HC) are the product of incomplete combustion.
C. Particulate matter (PM): The worse the fuel quality is, the more the carbon particles are generated. The black fumes of the diesel/oil engine are mainly consisted of the carbon residual. These small matters will suspend in the air for long time, and they are very easy to be taken into our respiratory systems. The PM causes bad health effects, including to respiratory disease and cancers.

The carbon particle in the exhausted fume is also a reason why there are so many respiratory patients existing in the circumstance of the traffic jam section of big cities or the main roads.

As a result of our long term studies, we found that there was a root cause of this incomplete combustion. It is the phase boundary potential of the various substance in the nature. Everything on the earth will be affected by the terrestrial magnetic field, and carry either Positive (+) or Negative (−) potential on its surface. The type of the potential that a matter carries is up to its nature, but the strength of the potential could be affected by outer environment or other extra factors.
A. Normally the organic fuel molecules (gasoline, diesel, heavy diesel, Aviation kerosene, ethanol, methanol, LPG, LNG etc.) carry positive (+) potential due to the affection from the earth magnetic field and the static electrics caused by the oxidation and frictions during stock and transportations. Above all, the organic fuels are known as Dielectric Materials, they are very easy to absorb electric charges, e.g. we need release the static charges from an oil tank lorry to the ground via conductive wires of chain . . . if we deposit the static potential too much, it will be very dangerous when the static electric discharged at very high voltage. This will cause explosion or serious fire, the Electrostatic fire!
B. Furthermore, organic fuels that refined from the oil do not only have single contents, it is a complicated mixture of certain kinds of organic contents and sometime contents water molecules. The different type of complicated potentials of these molecules affect each other, create molecules-clusters inside the fuel liquid. Thus, despite the most advanced fuel injection technologies, people still cannot crush the clusters yet. This means that the fuel mists injected into the engine chambers contents different sizes of clusters, this will cause combusting speed differences.
C. And the organic fuel will absorb moistures from the air, the water molecules will also ties with fuel molecules. When igniting the Air-Fuel mixture mists, the water molecules beside the fuel molecules will absorb a lots of heat to decrease the combustion temperature, this mechanism also generate the incomplete combustion.
D. The air molecules are also carrying positive (+) potentials due to the multi affections from the terrestrial magnetic field, Ultra violate (UV), electric magnetic radiation from the electronics facilities. The water molecules in the air also carry positive potential too. These water molecules are very easy to move to the engine chamber walls or fuel clusters with weaker potentials and absorb heats from them. These water molecules from the air will also affect the combustion efficiency badly.
E. The internal surfaces of engines and fuel injection systems are built from metals, and all metal automotive parts are grounded, thus, the metal surfaces carry negative (−) potential as well.
   [001]. The above materials that carry different potentials (+ VS −) will affect each other by electrical stimulation. This is the reason that causes the two types of incomplete combustion of internal combustion engines. See below:
1) The mixture mists carry positive (+) potential, a part of them will be attracted by the surfaces of metal parts (carrying negative (−) potential), and some mists will be stacked on the metal surfaces and reunion to become a kind of thin liquid layer of fuel-air mixture. The metal parts will absorb huge heat from the layer when ignition happens. Of course the fuel on the metal surfaces could not be combusted, but burned at much lower temperature. The issue is that the pistons will move up quickly within very short timing, there would not be enough time to completely ‘burn out’ the fuels on the metal surfaces. This is an incomplete combustion of fuel in the cylinders.
2) The fuel mists themselves also have incomplete combustion cause due to the uneven sizes of fuel-air clusters. The larger the clusters are, the slower combustion speeds are, the higher possibilities of incomplete combustion happens.

The above two types of incomplete combustion will generate a series of harmful or toxic residues in their exhaust gases:
1. Carbone residues→The carbon particulate matter (PM) will be partially wiped out at the pistons, to become the PM in the exhaust gas. And other parts of the PM will stack on the internal surfaces of the engine's parts, this causes the Carbon Deposition inside the engine.
2. The incomplete combustion will generate toxic gases such as Carbon monoxide (CO) and Hydrocarbons (HC).
3. The incomplete combustion of fuel also remain oxygen inside the cylinders, the oxygen will react with the N2 in the air and the Sulfur (S) in the fuel under a high-pressure and high temperature environment of cylinders. This will generate NOx and SOx in gasoline engines.

The incomplete fuel combustion will bring a series of pollutions and negative affections to the environment and societies. As to China, its energy consumption increased sharply, and the numbers of automotive cars also keep increasing significantly. We can hear the bad news regarding the air-pollutions in China every day, and the new trend of the pollution of China is mostly caused by the motor cars, lorries and buses that using organic fuels such as gasoline and diesel. In China, the PM pollution has become the most popular word, the black gases from the diesel engines has caused serious air pollution and series of respiratory disease and cancers. NOx and SOx, also cause precursor to smog and acid rain. Both of USA and China need to import huge quantity of oil to support their energy consumptions. But the oil prices have been driven up by the strong demand from China and other countries. On the other hand, the fuel incomplete combustion wastes a huge quantity of oil energy too. The International Greenhouse Gas Emissions has launched Carbon Gas control targets to the industrial counties, how to use the oil energy efficiently and how to reduce unnecessary energy wastage will be a very important national strategy of the government.

### SUMMARY OF THE INVENTION

### Object of the Invention

In order to overcome the shortcomings of incomplete combustion of modern engines, this invention provides an ideal process that could significantly increase the combustion ratio of fuels, this process can also increase the output power and torque by increasing the combustion ratio of fuel. For gasoline engines, the complete combustion can consume most of the oxygen in the Air-fuel mixtures and this could reduce the NOx and SOx too. Complete combustions could also reduce the Carbon PM significantly, this will prevent the PM pollution to the air and also prevent carbon deposition in the engines and the pollutions to the engine oil. It can extend the life cycle of engine oils efficiently.

In order to achieve the above object, this invention provides a fuel magnetization treatment method comprises the following steps of:
1) installing at least one electromagnetic coil on a supply system supplying fuels to a engine combustion device, and connecting two electrodes of the coil to an electromagnet generator.
2) providing alternate current (AC) to the coil with the electromagnet generator, so that the coils produce alternate a magnetic field, by which the fuel to be delivered to the engine is magnetized; wherein the band of the AC is 4 KHz˜25 KHz.

Preferably, the supply system comprises a fuel tank, a fuel supply tubing, an air supply tubing, and an air filter, the fuel tank being connected with the combustion device via the fuel supply tubing, and the air filter being connected with the combustion device via the air supply tubing.

Preferably, the coil is winded on the fuel supply tubing.

Preferably, the coil is winded on the fuel supply tubing and the air supply tubing, respectively.

Preferably, the coil is winded into a volute-shaped coil, attached to an insulator and then applied with a ceramic layer, so that a coil module is formed; the coil module can be installed in the fuel tank, in the air filter, on the periphery of the fuel supply tubing or the periphery of the air supply tubing, or installed in combination of any way above.

Preferably, the AC has a single frequency.

Preferably, the AC is a single AC simultaneously having several different frequencies.

Preferably, the AC has a frequency varying as a function of time.

Preferably, the engine includes gasoline engines, diesel engines, heavy oil engines, and gas turbine.

### Advantages of the Invention

Compared with the prior engine technologies, this invention uses electromagnetic field generator unit to provide special AC magnetic fields, and uses this special magnetic field to process the fuels (liquid or gas). With using this magnetization process, it is very efficient to control the polarity of the phase boundary potentials of the fuel flow molecules: to neutralize the electric polarity of the flow molecules as demanded, i.e. electric neutralization and magnetic neutralization; or to charge the flow molecules particles to a negative (−) phase potential or to a positive (+) phase potential. The application of alternate current magnetization to the engine fuel is mainly to make the flow (fuel, air, engine oil) to have a negative (−) phase potential, so as to achieve the following effects:
(1) To prevent fuel particles or molecules of water from being attracted the inner surface of the engine's combustion chamber. The mechanism is, the internal surfaces of the chamber carrying negative (−) potentials, which will naturally reject the fuel particles with negative potential and water vapor particles. This will prevent fuel particles or water vapor particles from adhering on the internal surfaces of the combustion chamber (Cylinder wall, Top of piston, surfaces of air valves). Driven by the electrical effect, the fuel particles will be fully suspended and form an even mixture gas in the combustion chamber with the air.
(2) To prevent the fuel from clustering. All the molecules have been charged with negative (−) potential, the fuel cluster will rejects each other, it could pulverize the uneven fuel clusters from inside. This effect can also prevent fuel molecules from reforming clusters too. The smallest fuel particles mixed with the smallest air particles could achieve an outbreak of complete combustion. Significant complete combustion will consume all the organic molecules in the fuel, there will cut off the residues of toxic gases, such as carbon monoxide (CO) and hydrocarbons (HC).
(3) To prevent the harmful oxidations: due to impurities in the fuel (mainly sulfur, moisture) phase potentials were also changed into negative (−) type, the sulfur molecules and fuel molecules would reject each other and become separated. The Oxygen also carry negative potential, there will be an electrical effect that could disturb the reactions between sulfur molecules and oxygen. This electric buffer effect could reduce the sulfur dioxide (SO2) emission. This could prevent Air pollution. Due to the water molecules contained in a fuel and the air also be charged with negative (−) potential, the separation movement between the fuel particles and the water molecules also happens. This will prevent water molecules involved in the combustion reaction.

Thus, after the AC magnetization treatment, the air and the fuel mixture taken into the cylinders and being compressed, then ignition. The combustion speed will be much faster and the reaction will be much more intensely, the combusting peak temperature will be increased and the pressure of gas expanding will be higher too. All these changes will increase the force power to push the piston down faster, of course, the output of the engine will be increased. Compared with the normal engine technology, an engine that uses this invention could achieve higher power performance with consuming lesser fuel. And this will also reduce Carbon dioxide and other harmful emissions too.

### DRAWINGS

FIG. 1 is the installation diagram that shows the invention system provides the Negative electromagnetic processing to the fuel supply pipe to engine and the air supply pipe engine.

FIG. 2-1 is the electric suspension model of fuel particles that carry negative (−) potentials in the engine combustion chambers (cylinders). After the Negative electromagnetic Process with this INVENTION, the fuel particles (−) will receive rejection power from the metal inner wall of the cylinder. The ‘←→’ shows the (−)/(−) electric rejections between Fuel particles and Cylinder Wall.

FIG. 2-2 is the diagram that shows the planktonic move mode of fuel particles in the cylinders. The processing was done by a so-called ‘Fuel Saver’ in the market, all these ‘Fuel Saver’ can only provide Positive (+) magnetic Process to the fuel. After the positive treatment, the fuel particles in the combustion chamber of the engine (i.e. the cylinder) carry positive (+) potentials. Although the fuel particles will reject each other, they will be attracted to the cylinder wall surface that carry strong Negative (−) potentials. The ‘←→’ shows the (+)/(+) rejections between fuel particles.

FIG. 2-3 shows without any magnetic processing, the electric suspension model of fuel particles in the engine combustion chambers (cylinders).

FIG. 3-1 is a schematic circuit diagram of this invention it shows the electromagnetic generator outputs single frequency AC current to the system.

FIG. 3-2 is a schematic circuit diagram of this invention it shows the electromagnetic generator AC outputs AC magnetic fields with mixed multi frequencies.

FIG. 4-1, FIG. 4-2, FIG. 4-3, FIG. 4-4 are the graph charts that showing the relationship between the AC electromagnetic field strength and their frequencies at the AC electromagnetic coil modules. The AC currents are output by the AC electromagnetic generator of FIG. 3-1 and FIG. 3-2.

FIG. 4-1 shows the AC magnetic field intensity curves near 5 KHz, and it has two peaks.

FIG. 4-2 shows the AC magnetic field strength curve between 4 KHz to 8.5 KHz, but its peak is near 8 KHz.

FIG. 4-3 shows the AC magnetic field strength curve between 4 KHz to 25 KHz, and this graph has a stable flat peak at all band range.

FIG. 4-4 shows the concept of AC magnetic field strength curves for multi narrow bands. The band width and peak values of the AC magnetic fields strengths could be generated for needs.

FIG. 5 shows the ZETA potentials graph of the titanium oxide fine particles in the calcium chloride aqueous. The chart shows the changes of the ZETA potentials before and after the AC electromagnetic processing which generated by the AC electromagnetic generator in FIG. 3-2. The standard ZETA potential of the titanium oxide fine particles in calcium chloride aqueous was ‘0’ Zero.

FIG. 6-1 shows the schematic diagram of a processing system that installing (winding) one unit of electromagnetic coil-modules on the fuel supply line and the air supply pipe engine.

FIG. 6-2 shows the schematic diagram of a processing system that winding two units (or more) of the electromagnetic coil-modules on the fuel supply line and the air supply pipe engine.

FIG. 7-1 shows the schematic diagram of a processing system that install a special ceramic coated electromagnetic coil module in the fuel Tank. Provide AC magnetic process in the fuel.

FIG. 7-2 shows the schematic diagram of a processing system that install a special ceramic coated electromagnetic coil module in the Air supply pipes.

FIG. 7-3 shows the schematic diagram of a processing system that install a special ceramic coated electromagnetic coil module on the inner wall of the fuel tank, but the coil-module is installed above the fuel surface.

FIG. 8-1 shows the schematic diagram of a processing system that install special ceramic coated electromagnetic coil modules at outside of the fuel and air supply pipes. The coil-modules will provide remote electromagnetic affection to the fuel flow and air flow in the pipelines.

FIG. 8-2 shows the schematic diagram of a processing system that installing special ceramic coated electromagnetic coil-modules on the outer wall of the fuel tank. The coil-modules will provide remote electromagnetic affection to the fuel in the tank.

FIG. 9 shows the schematic diagram the testing method of ZETA potentials test shown in FIG. 5 and the test equipment and system.

FIG. 10 shows the schematic diagram of internal structure an air purifying device of engine (air filter), and also shows winding Electromagnetic coil module installed on the air supply pipeline.

FIG. 11 shows the comparison chart of power-curve test results of a Toyota Caldina wagon's changes: before and after using the Invention Process.

FIG. 12 shows the comparison chart of power-curve test results of a Toyota Caldina wagon's changes: without using any process vs treated with electromagnetic processing+Ag coated metal mesh.

FIG. 13 shows the comparison chart of power-curve test results of a TOYOTA ARISTO that without Air processing (Standard) and process the air supply with Silver-coated metal mesh.

FIG. 14 shows the comparison chart of power-curve test results of a Toyota Caldina wagon's changes: No-processing is the standard condition without using any Air Processing in its air-filter. Processed is to install a Ceramic Coated metal coil in the air-filter, and provide AC electromagnetic processing to the Air with this invention system.

FIG. 15 shows the comparison chart of power-curve test results of a Toyota Caldina wagon's changes: The car's transmission was fixed at 3rd gear, and kept cruising simulation comparison. “No-process” means tested at the car's original condition without using any extra treatment. “Processed” is to install a Ceramic Coated metal coil in the air-filter, and provide AC electromagnetic processing to the Air with this invention system.

### EMBODIMENTS OF THE INVENTION

Please see the following description linked with the attached figures of the invention.

This invention will be illustrated with the alternate electromagnetic processing to a fluidic fuel (gasoline) being taken as examples.

The invention is about fuel magnetization process. The process comprises the following steps:
To install the Electromagnetic Coil Modules on the tubes, hoses or pipes that supply fuels to the burners or chambers of the engines. Then connect the electrodes of the coils with conductive cables to a special AC generator Unit.
The generator unit outputs Special AC electric currents to the Coil Modules, when the AC electricity “pass through” the coil modules, the coils could generate Alternative Current type Electromagnetic Fields around them. The Special frequency band range of the AC electricity generated by the AC generator Unit is from 4 KHz to 25 KHz.
The supply system includes a fuel tank, fuel supply pipelines, air supply pipeline, and an air-filter.

The fuel tank is connected with the engine via the fuel supply pipelines.

The air-filter is connected with the engine via the air supply pipelines.

The engine includes gasoline engines, diesel engines, heavy oil engines, and gas turbines.

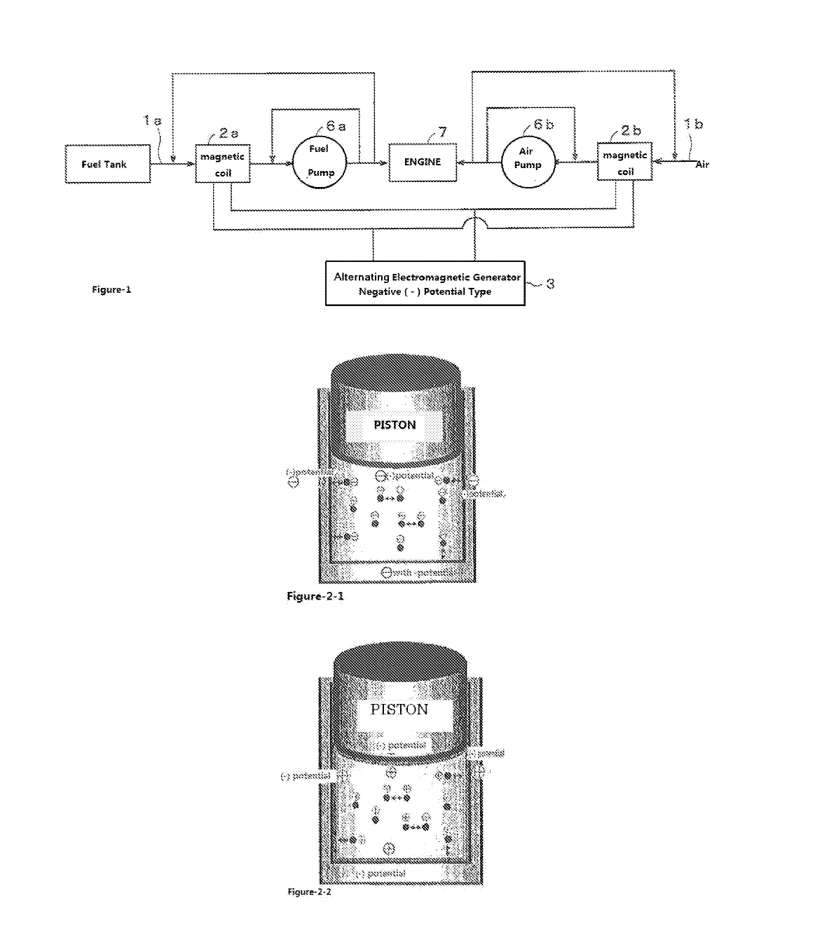

FIG. 1, shows to install (by winding) an electromagnetic coil (2a) on the FUEL supply pipe or hose (1a), and install (by winding) an electromagnetic coil (2b) on the AIR supply pipe (1b). Then connect the two coils with the AC generator Unit (3) shown in FIG. 3-1 or FIG. 3-2. The AC generator Unit (3) outputs special AC currents to the two coils (2a and 2b). The characteristics of current are:
A. A type of AC current which frequency is within the band range from 4 kHz to 25 kHz.
B. The current could be a single type AC current or a mixture of multiple types of AC currents:
(a) AC current with a single frequency;
(b) A mixture of AC currents group, with each individual AC current having its unique frequency;
(c) one or more AC currents each having time-variation frequencies.

The electromagnetic coils (2a) and (2b) can be deformed into electromagnetic coil modules. The basic method of making the electromagnetic coil module, is to set the wires fixed on the insulating sheet or circling film on flexible or rigid spiral shape, in which the sheet or film material for polyethylene terephthalate is a linear saturated polyester resin (PET), polyethylene (PE), polyimide resin (Polyimide). Apply ceramic coatings on the upper surface or the bottom surface, or both upper and lower surfaces. The binder resins for the ceramic coating, preferably to use epoxy resin, and add ceramic powder or ceramic fibers in the resins, and then apply to the substrates or other base material. The main component of ceramic powder or ceramic fiber containing cerium, Lanthanum, Neodymium, Phosphate ceramic component, is the natural or fine grinding after the removal of impurities made of ceramic powder, commonly known as negative oxygen ion ceramics. Characteristics of the ceramic coating has requirements are:
1) the radioactivity intensity is harmless to the human body, the ion diffusion effect can wear the thickness of transparent plastic or metal pipe wall below 3 mm;
2) No infrared radiation;
3) Particle fineness in #1000 meshes of ultrafine particles;
4) Ceramic layer by printing, for drying and sintering which are fixed on the insulating film with proper temperature after coating;
5) The ceramic layer has or does not have the flexible, rigid products can be thicker, but also for the flexible products thinner bendable.

Synthetic similar ceramic powder can also be used. Manufacturing method of the coating can be printing, spraying, laminating, and also sintering Construction of such coil module also can be prefabricated into similar to the printed circuit board (PCB) structure, on the surface by sintering or coating formed the ceramic layer. The coil module can also with the ceramic classification directly sintered into two-dimensional (or three-dimensional (plate) hollow half cylindrical or hollow cylindrical conductor coil), formed in the internal or external ceramic structures. The electromagnetic coil module can be opened with through holes or without through holes, processing according to the needs of practical use. The Module's internal conductor spacing density and configuration can be installed in accordance with the object into the design and adjustment, the mounting methods could be adjusted depends on the characteristic of the engine's fuel and air supply system. The coil modules can also be installed on the exhaust pipe to help to reduce the carbon residues as well as being installed on the fuel and air supply lines to the engine.

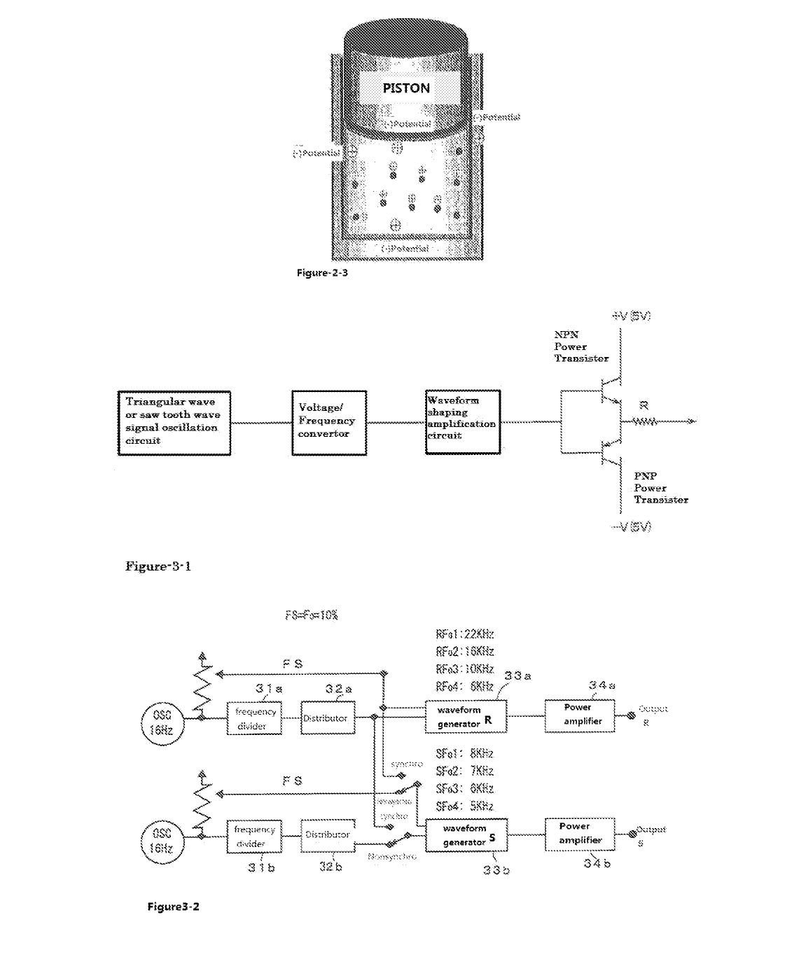

FIG. 2-1 shows a typical Fuel Particle's movement model in the cylinder of an engine: The fuel particles have been magnetized by the AC electromagnetic fields according to this invention. In this case the fuel particles carrying negative (−) potentials were forced to suspense in the cylinders by the electric potential effects. The diagram shows, fuel particles are rejected from the surface of the metal cylinder which also carrying negative (−) phase potential. At this condition, the fuel particles could not stack on the cylinder wall. All the fuel particles are mutually independent in the combustion chamber and mixed the Air particles which also carrying negative potentials very evenly. This even Air/Fuel mixture in the cylinder is a perfect condition for complete combustions.

FIG. 2-2 shows a typical Fuel Particle's movement model in the cylinder of an engine: The fuel particles have been magnetized by the magnetic field of a so-called ‘Fuel Saver” device sold in the market. These types of “Fuel Saver” devices either use very powerful permanent magnet or use DC electromagnetic coils to process the fuel flow. These “magnetization” processed could only make the fuel particles carrying even stronger Positive (+) potentials. Although the fuel particles were mutually independent each other, they would be attracted stronger by the engine chamber wall surface too, because the metal surfaces carry much strong negative potentials! In this sense the fuel particle that stacked on the metal surfaces of the cylinders and piston tops faster and will be increased to form a liquid layer of fuel. This layer is called Fuel Film on Engine inner Wall, of course, this fuel layer will become the main reason to cause incomplete combustions.

FIG. 2-3 shows a typical Fuel Particle's movement model in the cylinder of an engine: The fuel particles do not have any special processes before being taken into the engine chambers. The fuel particles only carry a weak and irregular level of Positive (+) potentials. There were lots of natural fuel clusters mixed with the air clusters too. Thus, a part of the fuel particles and clusters are stacked on the inner wall of the cylinders to form a liquid layer of fuel, and most of the other part are mixed with air in form of uneven particle clusters and suspended in the combustion chamber. Of course, such a status will cause incomplete combustions.

The system according to this invention is formed by a circuit that connecting the ‘AC electromagnetic field generator unit (3) (see FIG. 3-1 or FIG. 3-2) and the electromagnetic coil-modules. This system is installed in the engine system. The special AC currents generated by the Generator Unit (3) pass though the electromagnetic coil-modules (FIGS. 1, 2a and 2b), special AC electromagnetic Fields will be generated to magnetize the fuel supply flows and the air flows to the engine.

The operational principle of the “electromagnetic field generator unit (3)” with the electronic circuit of FIG. 3-1: This circuit actually has a Voltage-frequency converting function that filter the main source signals (having Triangle or Saw-tooth waveforms) and generate a voltage time-variation signal with a target-frequency band. Then an amplifier circuit will increase the output energy of the signals waves. This circuit can be modified easily to determine and optimize the wave-shapes and frequency bands and the current intensities. And the optimized AC currents generated by the ‘generator unit’ was send to the Electromagnetic Coils installed on the fuel supplying pipes (2b) and the Air supplying pipes (2b) in FIG. 1. This system also allow to only use the coils on fuel supplying pipes (2b), or the Air supplying pipes (2b) in FIG. 1 individually.

The “Generator Unit” can also use the electronic circuit design shown in FIG. 3-2. The working principle of this circuit is: To use an oscillating circuit or an functional device (OSC) to generate oscillate signals with a proper frequency. Then use 2 sets of frequency dividers (31a and 31b) to separate the signals. The signals from 31a (or 31b) pass through the Wave-generator 33a (or 33b) in the R (or S) system. Then mix the 2 individual signals together and let this composited signal pass through the amplifier circuits (34a and 34b) to enlarge the currents intensities with the required frequencies. Then let the generated currents signal pass through the Electromagnetic Coils installed on the fuel supplying pipes (2b) and the Air supplying pipes (2b) in FIG. 1. This output signal flow is mixed from two signals having different frequencies and intensities.

For example: when we send a signal distributed by 32a to the waveform generator, 33a and 33b, then we can obtained synchronous AC currents. However, if we send independent signals like the output from R system and S system (see FIG. 3-2) the 33a waveform generator and 33b waveform generator respectively, we can obtain asynchronous AC currents. The Generator Unit of this invention can output either synchronous AC current or non-synchronous AC current.

The electromagnetic field intensity that mentioned in this application means electromagnetic intensity in space, the unit of this intensity is V/m or A/m. The measuring method for this intensity maybe different depend on the different purpose of use. We use the unit of A/m in this invention. V means voltage, A means current, m represents the distance. The strength of the electromagnetic field generated at coil 2a (or coil 2b) has a Proportional relationship with the current intensities in the Coil 2a (or Coil 2b). We put a magnetic sensor at a position, and use the strength value that the sensor measured to express the value of the output strength of the magnetic field. The strength of the magnetic field generated by the electromagnetic coil modules show proportional changes if the current intensity in the coils changed.

The calculation formula is

P=K×I²×t,
P: The electromagnetic process energy [W] applied on the fluid (the fuel)
I: the current intensity in the electromagnetic coils (2a, 2b) [A];
t: The time of electromagnetic Processing [s];
K: fixed number [H/m³].

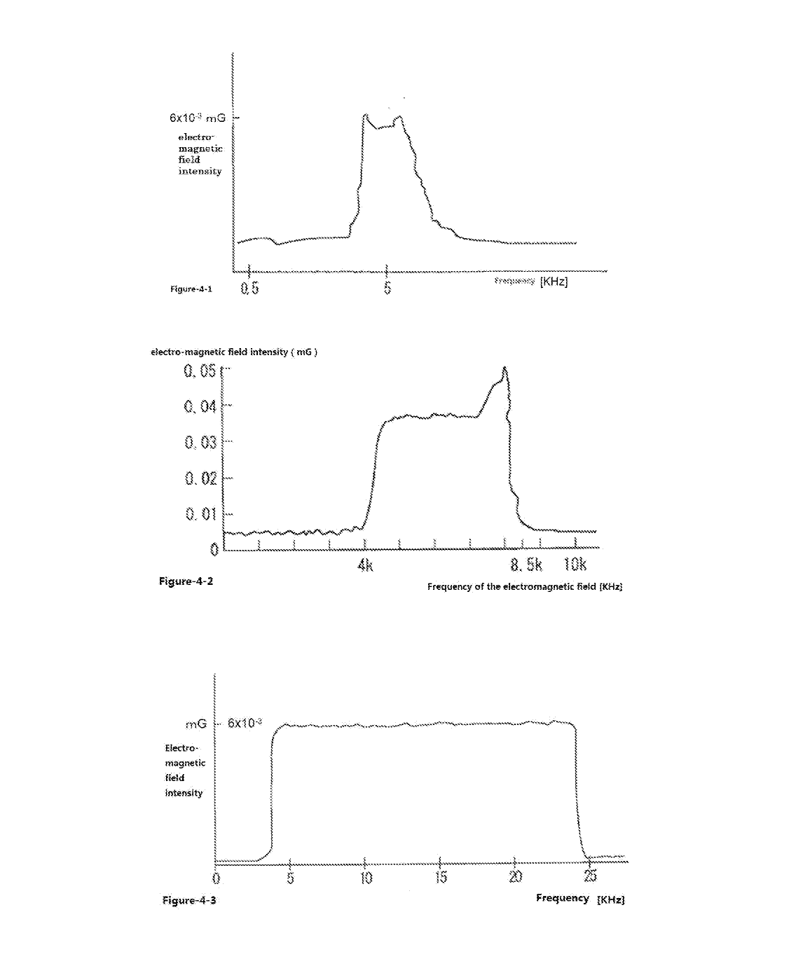

The electromagnetic generator unit (3) (here after, the generator 3, has the circuits of FIG. 3-1 or FIG. 3-2), can generate and output the signals with frequency-waveforms shown in FIG. 4-1, FIG. 4-2, FIG. 4-3, FIG. 4-4. The output waveforms could be square-wave, saw tooth wave, sine-wave or AC current signal with other waveform. Electromagnetic field generator 3 can generate AC electromagnetic field such as various frequency and waveforms shown in FIG. 4-4 through the electromagnetic coil. The 4 types graphs in FIG. 4-4, show the different types of AC electromagnetic field strength: Solid line=6000 Hz/Peak, DOT Line=10000 Hz/Peak, 1-dot-break line=16000 Hz/Peak, 2-dot-break line=22000 Hz/Peak. The Generator (3) can output a Time-Variation frequency AC current that between 4000 Hz to 25000 Hz, and use the coils to generate the electromagnetic wave as shown in FIG. 4-1, FIG. 4-2, FIG. 4-3. The generator (3) of this invention can generate and output single or multi signals that have a time-variation frequency 4000 Hz to 25000 Hz.

The results of our long term Research have proved that when we use the Special AC electromagnetic energies that generated by the Generators Unit (3) (FIG. 3-1, FIG. 3-2) to process the following test objects, the interesting phenomenon shown that we can arbitrarily change the interface potential of the test object materials either from (−) to (+) or from (+) to (−). In another word, we can change the interface potential of a materials freely with the system according to this invention.

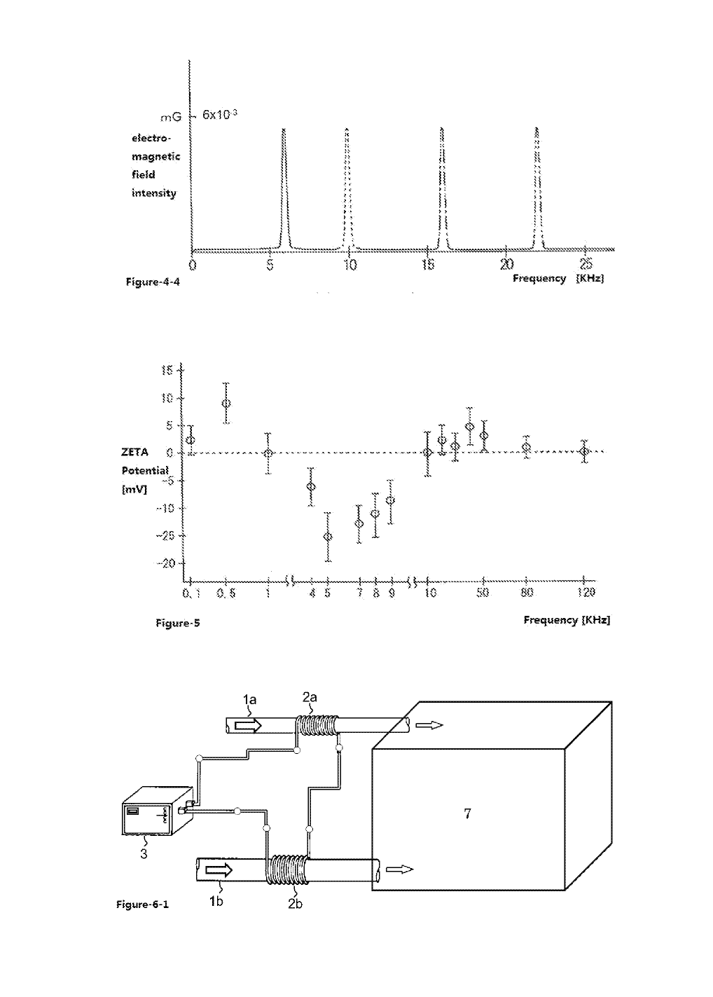

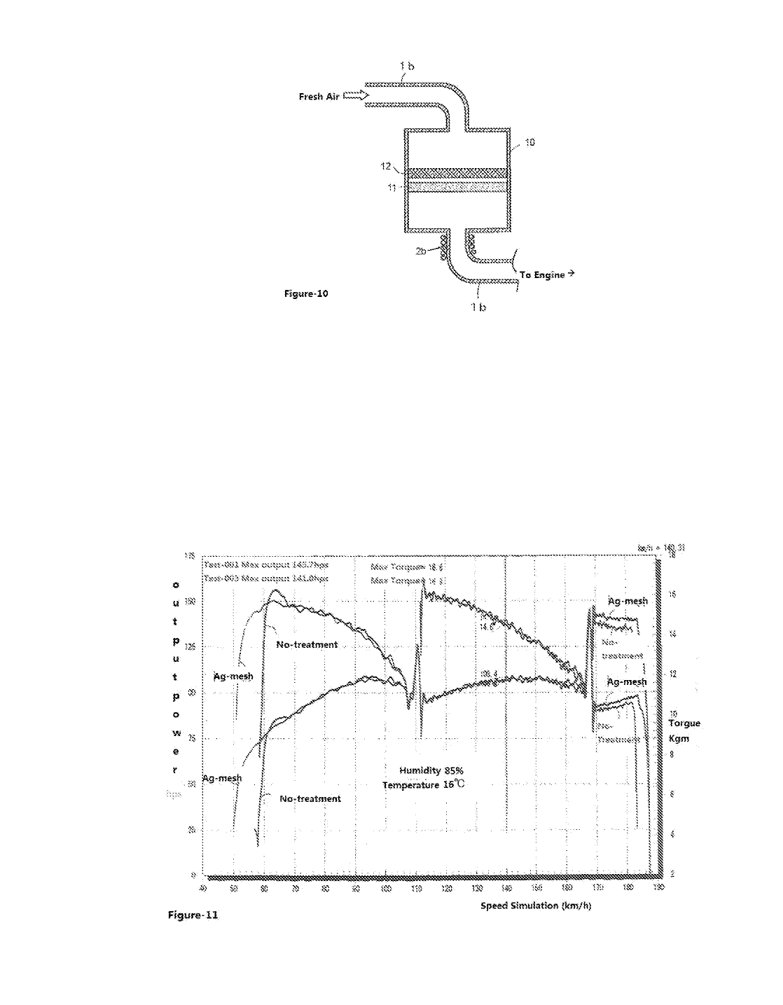

We prepared an Electromagnetic Processing system as shows in FIG. 9, the Generator Unit was connected to a Sleeve coil-module, this coil over rapped an pipe. The AC current generated by the generator (3) and pass through the coil, then a special electromagnetic field energy would be generated by the coil. We used this system to produce magnetization process to the Potassium chloride aqueous solution containing titanium oxide particles, the ZETA Potential of the liquid changed as the FIG. 5 shown.

The methods and procedures of measuring ZETA potential:
(1) ZETA potential measurement device:
   Electrophoretic light scattering photometer tester (ELS-800).
   Manufacturer: Otsuka Electronics (Japanese)
(2) Test object solution:
   Solute—Titanium oxide particles (ions diameters, 100˜200 um)
   Solution-10 millimol Potassium chloride (KCl) aqueous solution
   Regulating agent: pH 5.5
   Test temperature: 25
(3) Processing System: Invention system included the AC magnetic field generator (FIG. 3) and the coil Sleeve

Test Methods and Procedures:

Use the generators according to this invention (FIG. 3-1 and FIG. 3-2) to generate 1.0 A AC current and let the AC current pass through the Electromagnetic Coil Sleeve, there will be a type of AC electromagnetic field produced by the coil. The strengths and the frequencies of the AC electromagnetic fields are shown in diagram 4-1, 4-2, 4-3, 4-4.

As illustrated in the system in FIG. 9, we winded a piece of wire on the PVC pipe 20 laps to make electromagnetic coil sleeve (2a). We put the test object liquid (2) into a glass beaker (24). Then put the beaker inside of the PVC pipe with the Coil Sleeve. Then used the generator unit (3) to produce 1.0 A AC currents that had 3 different frequencies to the coil sleeve (2a), the processing duration was 1 minute each time. Then collected the “Processed Liquid” via the pipe (25) on the bottom of the beaker, and put the liquid to the ZETA potential measurement instrument (26) to test its ZETA potential.

During the test, the frequencies of the AC currents passed the coil sleeve (2a) were: 0.5 KHz, 20 KHz, 40 KHz, 60 KHz, 80 KHz . . . 120 KHz. As the benchmark, the beaker 24 without any electromagnetic processing of sample solution through the discharge pipe 25 to ZETA potential tester 26, testing the ZETA potential.

FIG. 5 shows the relevant chart between the ZETA potential changes after being processed by AC electromagnetic field of different frequencies and the current frequencies of the AC electromagnetic field used for the processing. The graph shows the differences between the Zeta potential (dotted lines) of every “Processed Liquid” and the “Unprocessed liquid”. All the data input were the average value of 5 same tests.

The configuration installing Electromagnetic Coils (2a, 2b) on internal combustion engines:

FIG. 1 shows the implementation of installing this system to the internal-combustion engine (7) (here after ‘Engine’) of Automotive Cars, or power-generators. The installation of the electromagnetic coil (2a) on the fuel supply lines and the electromagnetic coil (2b) on Air-supply pipes could be achieved by wrapping isolated electric wires on the outer periphery of the fuel supply pipelines (1a) and the air supply pipelines (1b). The generator unit (3) produces the following AC currents with Special frequency and strength to the coil modules (2a,2b) as required:
(1) The AC current with a single frequency
(2) Mixture of AC currents that have individual frequencies
(3) The AC currents that have time-variation frequencies.

When the special AC currents electrify (pass through) the electromagnetic Coil-modules, the coil-modules could produces AC electromagnetic fields. The AC electromagnetic fields can penetrate the fuel supply line (1a) and the Air supply pipeline (1b). The fuel flows in the fuel supply pipe lines (or the air flow in the air supply lines) will be magnetized by the AC electromagnetic fields, and carry proper unique Potentials, this is process is called The magnetization process. The magnetized fuel and air are compressed or taken into the Engine (7) by the fuel injection systems pump (6a) or Air compressor (6b). The fuel and the Air will become Fuel/Air mixture (Multi-Port injection Gasoline engine) be taken into the cylinders, or be taken into the cylinders individually (Diesel engines and Fuel Direct Injection engines). Some of the engines have ‘Fuel Return System’ that can return the over supplied magnetized fuels the fuel supply line (1a) again or back to the fuel tanks

However, the penetrating efficiencies of the electromagnetic field lines will be affected by the materials of the tube wall of the fuel pipe lines (1a) and Air supply lines (1b) The transmissivity of the electromagnetic field force strength that could penetrating the material will be in an order as below:

Lest-Iron (steel) pipe<Stainless steel Pipe<PVC (or other non-metal materials) Pipe.

When the electromagnetic coil is arranged pipe material for the magnetic field to penetrate materials, the need to increase the current intensity of electromagnetic coil to ensure AC magnetic field is strong enough to reach the interior of the pipe, realize the magnetization effect on fuel and air.

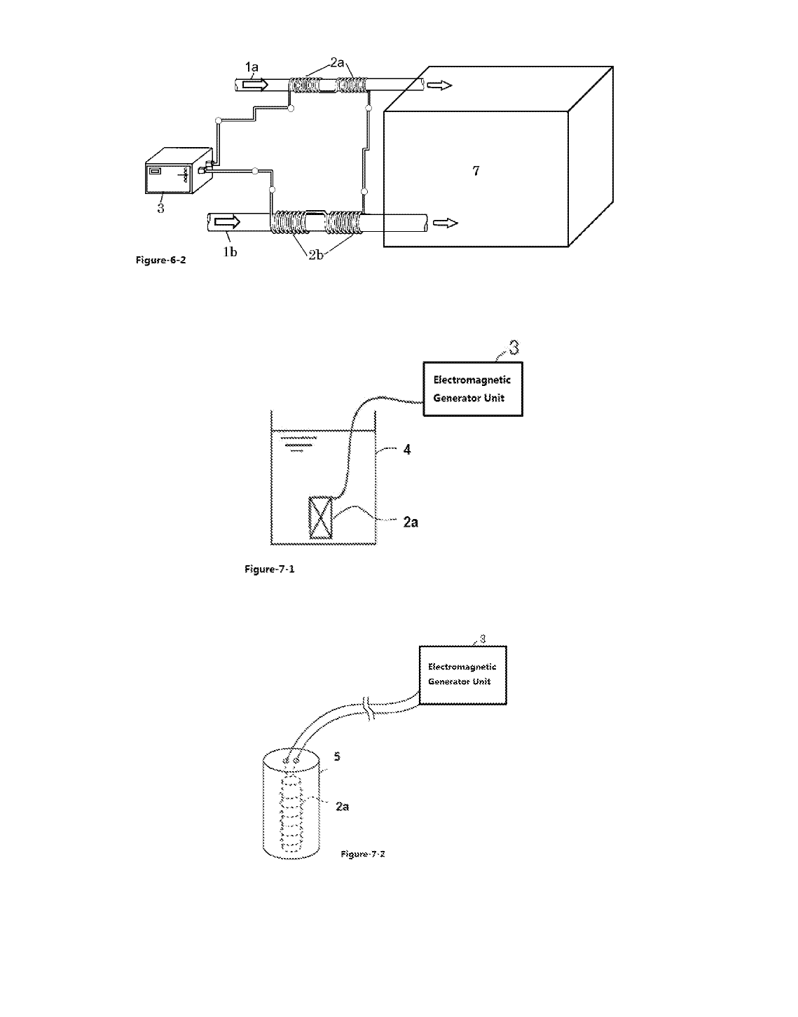

FIG. 6-1 shows the system diagram of an engine (7) being installed this invention with installing one Coil-module (2a) on the fuel supply line (1a) and one Coil-module (2b) on Air supply line (1b). This system could be normally suitable to the small capacity engines (below 2000 cc). FIG. 6-2 shows to install two and more Fuel processing Coil-Modules (2a) and Air Processing Coil-Modules (2b) on the fuel supply lines (1a) and air supply pipeline (1b). This installation configuration is mainly suitable for large capacity (>2000 cc) engines (such as heavy trucks, heavy-oil engine).

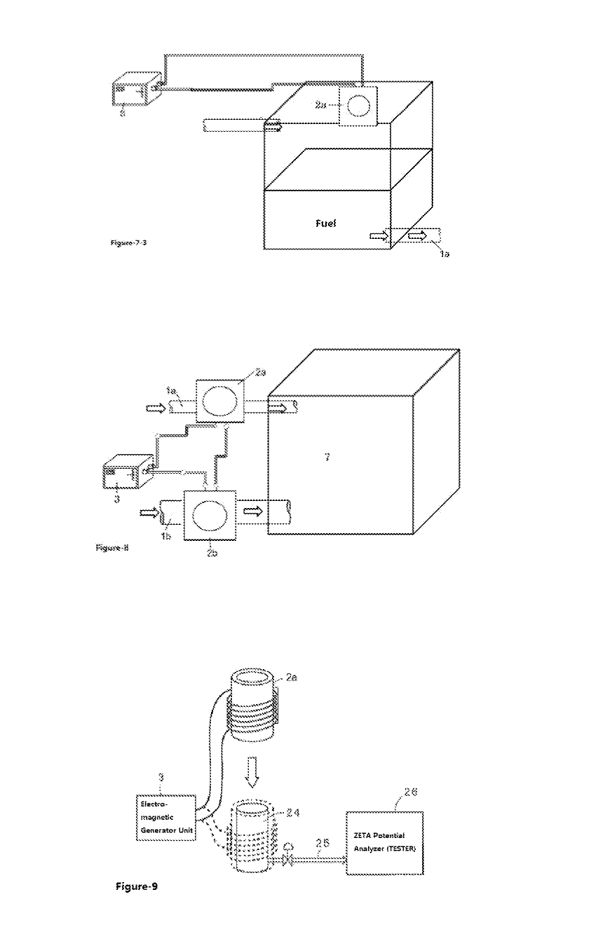

FIG. 7-1 is the diagram to install the Flat type Fuel Processing Electromagnetic Coil module (a) inside the fuel tank of an engine system. The surface of the coil module is specially treated so that we cannot see the coil from outside. When the electromagnetic generator (3) output AC currents to this module, the Coil-module will release AC electromagnetic fields to the fuels inside the tank. For example, the ceramic electromagnetic module has oil resistant and explosion-proof treatments, can be directly installed into the fuel storage tank (4), its AC magnetic field can directly generated inside the tank and provide fuel magnetization treatment. The purpose of installing this coil module inside the tanks, is to avoid the ‘electromagnetic shielding’ of the fuel or air supply lines (1a, 1b) of the engine system shown in FIG. 1. When the fuel supply line (1a) and air supply pipeline (1b) are fully made from metals (steel, cast iron, stainless steel etc.), the transmissivity of the electromagnetic field force strength inside the pipe lines will be very weak, it could not provide enough magnetization treatment to the fuel fluid and the air flow inside the pipe. The only method is to install the coil modules directly into the Fuel Tank or Air filter Housing as shown in FIG. 7-1. In this way, the ceramic coil module (2a, 2b) inside the fuel tank or the air filter could provide efficient magnetization treatment to the fuel and the air. And FIG. 7-2, we also found that to install a coil module inside a sealed and isolated box could also present very good magnetization effect. FIG. 7-3 shows to attach the “external radiation ceramic coil-module” on oil tank wall, but installed above the fuel level, but not immersed in liquid fuel. The FIG. 7-1, FIG. 7-2, FIG. 7-3 are showing the methods of using “external radiation ceramic coil module” for fuel and air magnetization treatment. These methods can achieve good treatment effect with the smallest electromagnetic intensity.

Installing the ‘Ceramic electromagnetic coil-module (2a, 2b) inside the Fuel tanks or air filter housings could improve the Magnetizing efficiencies. When install the coil-modules (2a,2b) inside, we can reduce the output power of the generator unit (3) can reduce the energy consumption of the Generator Unit (3). Another advantage of installing Coil-modules inside the fuel tanks is to neutralize the Positive Potential that the fuel carries naturally, and keep the fuel carrying Negative (−) potential, it can significantly prevent the nature oxidation of the fuel and extend the shelf life of the fuels.

To provide Negative Potential Magnetization process to fuel from inside has many advantages: To soak the Ceramic Electromagnetic Coil module (2a) in the fuel could directly magnetize the fuels efficiently with very little electromagnetic energy loss. And since the fuel was not flowing (or flow rate is very low) in the storage tank (see FIG. 6-1 or FIG. 6-1), the fuel could have enough time to be fully Magnetized. Therefore, the adjustment and the control of the time of irradiation are relatively simpler. Above all, this method is not affected by the pipeline (1a) material, can be directly implemented electromagnetic radiation on liquid fuel. However, we must know, we need to be very careful to using this method: we need high level insulation to the electromagnetic coil module and also need strictest explosion-proof and corrosion-proof coating. In the use of security should be extremely cautious, and built-in electromagnetic module cost will be higher.

The test results also proved that the Coil-module (2a, 2b) could be installed outside the fuel pipeline (FIG. 1, 1a) and the Air supply pipe line (FIG. 1, 2b), but these Coil-modules are coated with special Harmless Radioactive Ceramics. To install harmless radioactive coil-modules to an engine system (FIG. 8)'s fuel pipe line (1a) and air supply pipe (1b). The weak and harmless radiation energy of the ceramics could assist and increase the Electromagnetic coil module to provider higher processing performance to the fluids in the pipes than the Normal Coil modules. And this can reduce the influence of the pipeline wall materials to the magnetization.

### Embodiment 1

Table 1 is exhaust gas analysis changes of an engine which has been installed a coil (2a) on the fuel supply pipe (1a) and a Ceramics Coil module (2b) on the air supply pipe (1b). And a Generator Unit (3) which has the circuit of FIG. 3-1 or FIG. 3-2 outputs the special AC current signals to the coils 2a and 2b. The AC current signals are:
(a) AC current with a single main frequency, this invention system can be in accordance with the needs of the peak frequency range between 4000 Hz to 25000 Hz one or more output waveform signal;
(b) AC currents with different single frequencies mixed together. This invention can be in accordance with the needs of the peak frequency range between 4000 Hz to 25000 Hz a one or more of the output waveform signal;
(c) AC current(s) as shown in FIG. 6 having a time-variation frequency band between 4000 Hz to 25000 Hz;

The embodiment is tested on Japanese Kawasaki Corporation 750 cc motorcycle under the following conditions: our data shown in Japan Patent Gazette 2009-276042 test object for “Kawasaki Zepher750” exhaust volume 750 cc, model BCZR750CI. Under each condition testing time duration was 15 minutes or 20 minutes, the engine was at Idling RPM=1100±50 rpm. The exhaust analyzer was YANAKO KEIKI, (Japan) Mode number was ALTAS-201L.

TABLE 1
Test result of Kawasaki 750 CC motorcycle with Japanese Regular gasoline (#86)

| | | | | AC | AC | AC |
|---|---|---|---|---|---|---|
| | | | | Electromagnetic | Electromagnetic | Electromagnetic |
| | | | No | Process | Process | Process |
| | | | Treatment | (+) Process | 100 Hz~10000 Hz | (−) Process |
| Fuel consumption | | | 390 ml | 380 ml | 385 ml | 330 ml |
| (Idling 20 mins) | | | | | | |
| Exhaust | CO | Start | 3.0-3.5 | 0.05-0.09 | 0.03-0.08 | 0.02-0.03 |
| gas | ppm | 15 min | 5-5.5 | 0.2-0.8 | 0.4-0.9 | 0.04-0.06 |
| analysis | | later | | | | |
| | HC | Start | 800-1000 | 1700-1900 | 1700-2500 | 180-250 |
| | ppm | 15 min | 1500-1700 | 800-1000 | 850-1200 | 100-200 |
| | | later | | | | |

From the Table-1 test results we can see that the characteristics of this experiment are: When use this system to provide the magnetization process the gasoline and the air with a frequency band of 4 KHz˜25 KHz, compared with the No-treatment results, the different magnetization processes have shown changes of fuel combustion ratios and fuel saving ratios. We also found that the “Negative potential type magnetization treatment” to gasoline had improved the fuel combustion ratios most obviously! And the Negative potential type magnetization treatment” could also reduce the harmful emissions of Carbon monoxides (CO) and Hydrocarbon (HC) most efficiently. The AC current used in the test to provide Negative Potential (− ZETA Potential) to gasoline and air had single frequency or time-variation frequency. The results show:
(1) The fuel efficiency of the idling engine without any fuel and air treatments was lower, its fuel consumption was relatively higher, and the harmful components in the exhaust gas were higher;
(2) The Positive potential magnetization treatment” achieved 3% of fuel saving performance, but this treatment could not reduce the hydrocarbon (HC) in the exhaust gas;
(3) The treatment to gasoline that used output frequency band of “100-10000 Hz” did not show obvious improvement in this test.

### Embodiment 2

To install a electromagnetic coil (2a) on the fuel supply pipe (1a) and a electromagnetic coil (2b) on the air supply pipe (1b), wherein the electromagnetic coil (2b) is a electromagnetic coil module with a ceramic layer. And a Generator Unit (3) which has the circuit of FIG. 3-1 or FIG. 3-2 outputs the special AC current signals to the coils 2a and 2b. The use the AC magnetic field generated by the coils (2a and 2b) to magnetize the fuel and air. When switched the generator off, we consider the treatment status as No-Treatment. The calculation method of output power is

W(Watt)=I(current) and V(voltage) that the generator could output

The AC currents have been shown in FIG. 6 which have time-variation frequency band between 4000 Hz to 25000 Hz. The AC current signals are:
(1) AC current with a single main frequency
(2) AC currents with different single frequencies mixed together.

(3) AC current(s) having time-variation frequency

Test conditions and method of Embodiment 2:
Exhaust gas analyzer: RIELLO JAPAN automobile exhaust gas analyzer (Auto5.1 series);
Gas analysis objects: Carbon monoxide (CO, %), Hydrocarbon (HC, ppm),
Carbon dioxide (CO2, %), Oxygen Residue (O2, %), Nitric Oxide (NO, ppm)
Test method: Insert the gas analyzer sampling probe to the exhaust pipe of the automotive, and record the analysis data of the exhaust gas from the tail pipe under Idling and various RPM condition. At the start and end of every RPM test, we made the engine back to idling first and then increased the RPM to our required RPM.
AC output by Generator (3):
   OFF-(No-treatment)=0 W→0 A ON-Treatment=1 W→10 mA
   ON-Treatment=3 W→30 mA ON-Treatment=5 W→50 mA
      Engine Revolution: see table-2˜table-5
      Installation of the Coil-modules: The electromagnetic coil 2a and 2b could be installed by winding isolated conductive cables on the pipe lines (1a, 1b) or attach the flat coil-modules on the pipe lines (1a,1b).
      Emission analysis test results: see table-2˜table-5.
      Automotive for testing: Table-2 HONDA Legend Sedan, Japan lead-free regular gasoline.

TABLE 2
Test result of HONDA Legend with #90 Un-Leaded Petro

| | Treatments | No-Treatment | | | | | Negative(−) Potential Type(1 W) | | | | |
|---|---|---|---|---|---|---|---|---|---|---|---|
| Exhaust | environment | Humidity 60.2% temperature 14.1 C. | | | | | Humidity 56.6% temperature 14.0 C. | | | | |
| emissions | RPM | 700 | 1000 | 1500 | 2000 | 2500 | 700 | 1000 | 1500 | 2000 | 2500 |
| CO | % | 0.81 | 0.63 | 0.22 | 0.10 | 0.10 | 0.01 | 0.01 | 0.01 | 0.01 | 0.00 |
| HC | ppm | 203 | 98 | 60 | 9 | 9 | 1 | 1 | 1 | 1 | 1 |
| CO2 | % | 14.8 | 15.1 | 15.4 | 15.6 | 15.6 | 15.6 | 15.6 | 15.6 | 14.9 | 14.9 |
| O2 | % | 0.95 | 0.71 | 0.23 | 0.09 | 0.09 | 0.20 | 0.09 | 0.08 | 0.11 | 0.09 |
| NO | ppm | 49 | 90 | 6 | 0 | 0 | 14 | 4 | 5 | 0 | 0 |

| | Treatments | Negative(−) Potential Type (3 W) | | | | | Negative(−) Potential Type (5 W) | | | | |
|---|---|---|---|---|---|---|---|---|---|---|---|
| Exhaust | environment | Humidity 60% temperature 14.0° C. | | | | | Humidity 60.% temperature 14.0° C. | | | | |
| emissions | RPM | 700 | 1000 | 1500 | 2000 | 2500 | 700 | 1000 | 1500 | 2000 | 2500 |
| CO | % | 0.00 | 0.00 | 0.01 | 0.01 | 0.01 | 0.01 | 0.01 | 0.01 | 0.01 | 0.01 |
| HC | ppm | 1 | 1 | 1 | 1 | 1 | 1 | 1 | 1 | 1 | 1 |
| CO2 | % | 15.5 | 15.5 | 15.5 | 15.5 | 15.6 | 15.0 | 15.0 | 15.0 | 15.0 | 15.0 |
| O2 | % | 0.10 | 0.09 | 0.08 | 0.08 | 0.08 | 0.10 | 0.08 | 0.08 | 0.08 | 0.07 |
| NO | ppm | 4 | 4 | 4 | 4 | 4 | 1 | 0 | 0 | 0 | — |

The results in table-2 shows that when the engine was at No-Treatment condition and the engine revolution was low, e.g. idling (700 RPM), the concentrations of hydrocarbon (HC) in tail gas was high. It means that the engine fuel has the incomplete combustion. At the same time, the concentrations of Nitric oxide (NO) and Carbon monoxide (CO) were also high. We found that the concentrations of HC, NO and CO would keep high level until the engine revolution reached 2000 RPM. The Oxygen Residue concentration would not decrease obviously either. This proves that when the engine RPM below 2000 in the presence of incomplete combustion phenomenon, therefore could not fully consume oxygen. On the contrary, when the engine revolution increased to 2000 rpm and above, the Oxygen residue in the exhaust gas began to be decreased. The engine began to combust the fuel completely, and the consumption of oxygen was also increased, nitric oxide (NO) concentration in the tail gas was reduced gradually, to close to 0. The reason for this phenomenon is more oxygen has been consumed in the combustion reaction. And there were much lesser oxidation residue could react with nitrogen. The engine could maintain an ideal air-fuel ratio, and achieved complete combustion. The 3-way catalysts could process the emissions efficiently. Amazingly, when we used the invention system to provide Negative-magnetization treatments to fuel and air, no matter how the engine rpm is, the harmful emissions (CO, HC, NO) concentrations in the exhaust gas were drastically reduced! And it is not difficult to find a high power (5 W) Negative-potential treatment presented best Complete Combustion performance! It shows that in the cylinders, the Air/fuel detonation reaction were very close to complete combustions! With the help of the 3-way catalysts, the harmful substances have been effectively controlled. The daily driving conditions of motor cars in cities, are normally the repeated cycle of “Start-Run-Stop”, the city-driving speed is generally below 50˜60 km/h, the engine revolution is basically around 1500 rpm. Therefore, this driving condition is very easy to cause fuel incomplete combustions and release harmful substances in the automobile tail gas, this will cause serious air pollution. However, as the table-2 has shown, with using the invention to provide Negative-treatment to the fuel and the air supplied to the engines, could effectively inhibit and reduce harmful substances in the exhaust gas! This will protect the environment from exhaust gas pollutions effectively.

TABLE 3
test result of a TOYOTA CROWN-Athlete (a high performance
car) with Japanese Premium gasoline (#96).

| | Treatments | No-Treatment | | | | | Negative(−) Potential Type(1 W) | | | | |
|---|---|---|---|---|---|---|---|---|---|---|---|
| Exhaust | environment | Humidity 39.2% Temperature 15.7 C. | | | | | Humidity 39.2% Temperature 15.7 C. | | | | |
| emissions | RPM | 600 | 1000 | 1500 | 2000 | 2500 | 600 | 1000 | 1500 | 2000 | 2500 |
| CO | % | — | 0.01 | 0.01 | 0.01 | 0.01 | 0.01 | 0.01 | 0.01 | 0.01 | 0.01 |
| HC | ppm | — | 1 | 1 | 1 | 1 | 1 | 1 | 1 | 1 | 1 |
| CO2 | % | — | 15.4 | 15.5 | 15.5 | 15.5 | 15.5 | 15.5 | 15.6 | 15.6 | 15.6 |
| O2 | % | — | 0.14 | 0.22 | 0.21 | 0.36 | 0.14 | 0.09 | 0.08 | 0.07 | 0.07 |
| NO | ppm | — | 0 | 117 | 245 | 331 | 0 | 0 | 0 | 0 | 0 |

| | Treatments | Negative(−) Potential Type(3 W) | | | | |
|---|---|---|---|---|---|---|
| Exhaust | environment | Humidity 39.2% Temperature 15.7 C. | | | | |
| emissions | RPM | 600 | 1000 | 1500 | 2000 | 2500 |
| CO | % | 0.01 | 0.01 | 0.01 | 0.01 | 0.01 |
| HC | ppm | 1 | 1 | 1 | 1 | 1 |
| CO2 | % | 15.6 | 15.6 | 15.7 | 15.6 | 15.7 |
| O2 | % | 0.15 | 0.09 | 0.08 | 0.08 | 0.07 |
| NO | ppm | 23 | 9 | 3 | 2 | 2 |

From the results of table-3, we can find that when used premium gasoline, if did not use the magnetization treatment of this invention to the fuel and the Air, the Nitric oxide (NO) concentration in the exhaust gas would increase sharply when the engine's RPM is above 1500 rpm. The premium gasoline has higher octane value and the combustion temperatures are higher than that of using regular gasoline. And the natural gasoline and the air molecules carrying Positive (+) potentials, all these conditions would increase the possibilities of the reaction between Nitrogen (N2) and the Oxygen, to create Nitrogen Oxide (NO). However, when used this invention's magnetization treatments to fuel and air, no matter the RPM of the engine was high or low, the Nitrogen Oxide (NO) in the exhaust gas shown lower levels. This was because that the fuel could achieve complete combustion and consumed almost all the Oxygen in the air. The Nitrogen could not be mass oxidized without enough. But the data in table-3 also shows that the control of the magnetization treatment strength is necessary! If the magnetization treatment strength to the organic fuel were too high, we would not get the best Emission-cut performance. The table-3 shows that the Emission-cut of the 5 W treatment has performed worse than that of 1 W treatment. And we need to declare that in this test, there was a sampling failure when taking exhaust gas sample from the untreated-engine at 600 rpm.

TABLE 4
Test result of the magnetization treatment for TOYOTA
Caldina Touring Wagon with Japanese #86 fuel.

| | Treatment | No-Treatment | | | | | Negative(−) Treatment (1 W) | | | | |
|---|---|---|---|---|---|---|---|---|---|---|---|
| Emission | Environment | Humidity 82% Temperature 11.5 C. | | | | | Humidity 82% Temperature 11.5 C. | | | | |
| Exhaust | Rpm | 650 | 1000 | 1500 | 2000 | 2500 | 650 | 1000 | 1500 | 2000 | 2500 |
| CO | % | 0.02 | 0.06 | 0.10 | 0.06 | 0.00 | 0.01 | 0.01 | 0.01 | 0.01 | 0.01 |
| HC | ppm | 104 | 54 | 16 | 3 | 1 | 1 | 1 | 1 | 1 | 1 |
| CO2 | % | 15.5 | 15.5 | 15.6 | 15.7 | 15.7 | 15.8 | 15.7 | 15.8 | 15.8 | 15.8 |
| O2 | % | 0.26 | 0.30 | 0.10 | 0.10 | 0.10 | 0.15 | 0.10 | 0.10 | 0.09 | 0.09 |
| NO | ppm | 1 | 8 | 0 | 0 | 0 | 0 | 0 | 0 | 0 | 0 |

| | Treatment | Negative(−) Treatment (3 W) | | | | | Negative(−) Treatment (5 W) | | | | |
|---|---|---|---|---|---|---|---|---|---|---|---|
| Emission | Environment | Humidity 82% Temperature 11.5 C. | | | | | Humidity 66.5.% Temperature 10.5 C. | | | | |
| Exhaust | Rpm | 650 | 1000 | 1500 | 2000 | 2500 | 650 | 1000 | 1500 | 2000 | 2500 |
| CO | % | 0.01 | 0.01 | 0.01 | 0.01 | 0.01 | 0.01 | 0.01 | 0.01 | 0.01 | 0.01 |
| HC | ppm | 1 | 1 | 1 | 1 | 1 | 3 | 2 | 2 | 1 | 0 |
| CO2 | % | 15.7 | 15.8 | 15.8 | 15.8 | 15.8 | 15.4 | 15.6 | 15.6 | 15.6 | 15.6 |
| O2 | % | 0.15 | 0.10 | 0.10 | 0.09 | 0.09 | 0.18 | 0.09 | 0.15 | 0.14 | 0.17 |
| NO | ppm | 0 | 0 | 0 | 0 | 1 | 0 | 0 | 14 | 84 | 90 |

The data of table-4 also shows the similar results as well as that of table-3. When the engine was at untreated (Normal) condition, the lower the RPM was, the lower the fuel combustion efficiency dropped, the higher the hydrocarbon (HC) concentration in the exhaust gas. Only when the engine rpm was above 2000 rpm, the engine could basically achieve a complete combustion. However, when used this invention's system to provide magnetization to fuel and air, it could make the engine achieve the complete combustion. Then the Nitric oxide (NO) and the Hydrocarbons (HC) emissions were also reduced almost to zero. Interestingly, when we increased the magnetizing treatment power, the Nitric oxide concentration was increased while the engine revolution was over 1500 rpm, but the concentration of hydrogen carbide (HC) didn't increase! We can speculate, nitric oxide produced by high engine speed is due to nitrogen oxidation temperature of combustion in the combustion chamber exorbitant, rather than due to the incomplete combustion.

TABLE 5
Test result of a NISSAN ELGRAND Mini Van using Premium gasoline (#90).

| | Treatment | No-Treatment | | | | | Negative(−) Treatment (1 W) | | | | |
|---|---|---|---|---|---|---|---|---|---|---|---|
| Exhaust | Environment | Humidity 57.3% temperature14.8 C. | | | | | Humidity 57.3% temperature 14.8 C. | | | | |
| Emission | RPM | 750 | 1000 | 1500 | 2000 | 2500 | 750 | 1000 | 1500 | 2000 | 2500 |
| CO | % | 0.00 | 0.04 | 0.01 | 0.03 | 0.01 | 0.01 | 0.08 | 0.07 | 0.01 | 0.01 |
| HC | ppm | 4 | 7 | 0 | 0 | 0 | 0 | 0 | 0 | 0 | 0 |
| CO2 | % | 15.6 | 15.7 | 15.7 | 15.7 | 15.7 | 15.7 | 15.7 | 15.7 | 15.7 | 15.7 |
| O2 | % | 0.13 | 0.09 | 0.11 | 0.10 | 0.09 | 0.10 | 0.08 | 0.08 | 0.08 | 0.10 |
| NO | ppm | 0 | 4 | 3 | 3 | 11 | 0 | 0 | 0 | 0 | 45 |
| | Treatment | Negative(−) Treatment (3 W) | | | | | Negative(−) Treatment (5 W) | | | | |
| Exhaust | Environment | Humidity 57.7% temperature 14.2 C. | | | | | Humidity 57.7% temperature 14.2 C. | | | | |
| Emission | RPM | 750 | 1000 | 1500 | 2000 | 2500 | 750 | 1000 | 1500 | 2000 | 2500 |
| CO | % | 0.01 | 0.08 | 0.06 | 0.00 | 0.01 | 0.01 | 0.02 | 0.01 | 0.01 | 0.01 |
| HC | ppm | 1 | 1 | 1 | 1 | 1 | 1 | 1 | 1 | 1 | 1 |
| CO2 | % | 15.8 | 15.8 | 15.8 | 15.8 | 15.6 | 15.8 | 15.8 | 15.8 | 15.8 | 15.8 |
| O2 | % | 0.14 | 0.09 | 0.08 | 0.08 | 0.10 | 0.14 | 0.09 | 0.08 | 0.08 | 0.10 |
| NO | ppm | 0 | 0 | 0 | 0 | 0 | 0 | 0 | 0 | 1 | 48 |

There was a operational error in this test, when the test staff was testing “untreated (Normal)” state of the engine, he forget to turn off the Generator Unit (See 3 of FIG. 1), which affected directly to the “strange phenomenon” in table-5. That was we could see obvious differences between the“untreated” exhaust gas and the “treated” exhaust gas.

From the data of table-2˜table-5, we could find that if a normal gasoline engine's revolution could not reach a certain high RPM, it would be very hard to reduce the harmful emissions (hydrocarbons, nitrous oxide) in its exhaust gas. However, by using the invention system to provide electromagnetic processing to the fuel and the air, the harmful emissions in the exhaust gas could be cutoff sharply from a very low RPM revolution to high RPM condition. The phenomenon would be that the concentration of ‘hydrocarbon (HC, generated by incomplete combustion) were reduced to almost 0 ppm. The Nitric oxide can also be reduced to almost 0 ppm. Usually a fuel complete combustion will increase the nitric oxide (NO) concentration due to the higher combustion temperature. But our test results have shown that with using the Invention System's magnetization process could reduce the Nitrogen Oxide (NO) by improve the complete combustion ratio of the fuels. The results also shown that the oxygen concentration in the tail gas also has been reduced! The inventor conjectured that the combustions of the “Magnetized Air/Fuel Mixture” that processed by the invention system, could achieve Complete Combustion (Ideal Combustion) much easier than the No-treated Fuel and Air mixtures. And the complete combustions would consume most of the oxygen in the air for ‘burning the fuel’, this would reduce the oxidation reaction of Nitrogen. Also, the Oxygen and the Nitrogen molecules carrying the same Negative (−) phase potentials that charged by the Invention System's Coil Modules, the Intermolecular repulsion oxygen and nitrogen molecules also perform “Electric Buffering” to disturb the Nitrogen molecules from Oxidation. At the same moment, the reducing of CO in the exhaust gas also proved that this invention system could promote the engine to achieve complete combustion effect at low speed conditions.

Although there are great differences between people's driving habits, but our daily drives (urban and low speed, especially traffic jams) would release harmful pollutants is an indisputable truth. The data of table-2˜table-5 have shown that by using of the appropriate magnetization of fuel and air (mandatory with negative potential) processing, can effectively improve fuel combustion efficiency of the car engines, and can effectively inhibit the harmful substances produced by incomplete combustion in our daily driving (“Staring→driving at a speed of 50 km to 60 km→Stopping” cycle).

Table-6 table-7, table-8 showing the test results in winter condition (Humidity 15%, 2 degrees Celsius). The test methods were as same as that have been used in the test of Table-2˜table-5. The magnetization treatment system was used was also the systems shown in FIG. 1.

TABLE 6
Test result of TOYOTA CALDINA Touring Wagon's using regular gasoline (#90)

| | Treatment | No-Treatment | | | | | | | | |
|---|---|---|---|---|---|---|---|---|---|---|
| Exhaust | Environment | Humidity 15% temperature 2 C. | | | | | | | | |
| Emissions | RPM | 500 | | 1000 | | 1500 | | 2000 | | 2500 |
| Test No. | | 1 | 2 | 1 | 2 | 1 | 2 | 1 | 2 | 1 |
| CO | % | −0.01 | −0.01 | −0.01 | −0.01 | −0.01 | 0 | −0.01 | 0.07 | −0.01 |
| HC | ppm | 47 | 2 | 7 | 2 | 0 | 0 | 1 | 3 | 1 |
| CO2 | % | 15.1 | 15.2 | 15.2 | 15.3 | 15.3 | 15.3 | 15.2 | 15.2 | 15.2 |
| O2 | % | 0.23 | 0.2 | 0.15 | 0.18 | 0.16 | 0.17 | 0.14 | 0.16 | 0.14 |
| NO | ppm | 0 | 0 | 0 | 0 | 0 | 0 | 0 | 0 | 0 |

| | Treatment | Negative Potential Magnetization Treatment (3 W) | | | | | | | | |
|---|---|---|---|---|---|---|---|---|---|---|
| Exhaust | Environment | Humidity 15% temperature 2 C. | | | | | | | | |
| Emissions | RPM | 500 | | 1000 | | 1500 | | 2000 | | 2500 |
| TEST No. | | 1 | 2 | 1 | 2 | 1 | 2 | 1 | 2 | 1 |
| CO | % | — | — | −0.01 | — | −0.01 | — | 0 | — | −0.01 |
| HC | ppm | — | — | 1 | — | 3 | — | 1 | — | 2 |
| CO2 | % | — | — | 15.3 | — | 15.3 | — | 15.4 | — | 15.4 |
| O2 | % | — | — | 0.17 | — | 0.14 | — | 0.15 | — | 0.16 |
| NO | ppm | — | — | 0 | — | 0 | — | 1 | — | — |

| | Treatment | Negative Potential Magnetization Treatment (5 W) | | | | | | | | |
|---|---|---|---|---|---|---|---|---|---|---|
| Exhaust | Environment | Humidity 15% temperature 2 C. | | | | | | | | |
| Emissions | RPM | 500 | | 1000 | | 1500 | | 2000 | | 2500 |
| TEST No. | | 1 | 2 | 1 | 2 | 1 | 2 | 1 | 2 | 1 |
| CO | % | — | — | −0.01 | — | −0.01 | — | −0.01 | — | — |
| HC | ppm | — | — | −1 | — | −1 | — | 1 | — | — |
| CO2 | % | — | — | 15.6 | — | 15.6 | — | 15.4 | — | — |
| O2 | % | — | — | 0.16 | — | 0.16 | — | 0.15 | — | — |
| NO | ppm | — | — | 0 | — | 0 | — | 6 | — | — |

TABLE 7
Test Result of a Daihatsu Motor Mover (660 cc) using regular gasoline (#90)

| | Treatment | No-Treatment | | | | | | | | |
|---|---|---|---|---|---|---|---|---|---|---|
| Exhaust | Environment | Humidity 15% Temperature 2 C. | | | | | | | | |
| Emissions | RPM | 500 | | 1000 | | 1500 | | 2000 | | 2500 |
| Test No. | | 1 | 2 | 1 | 2 | 1 | 2 | 1 | 2 | 1 |
| CO | % | 0.09 | 0.35 | 0.24 | 0.04 | 0.74 | 0.36 | 0.73 | 0.28 | 0.43 |
| HC | ppm | 103 | 170 | 183 | 92 | 239 | 138 | 220 | 99 | 104 |
| CO2 | % | 15.4 | 15.2 | 15.2 | 15.6 | 15.4 | 15.4 | 14.9 | 15.4 | 15.3 |
| O2 | % | 0.52 | 0.73 | 0.75 | 0.38 | 0.4 | 0.4 | 0.86 | 0.35 | 0.46 |
| NO | ppm | 7 | 119 | 115 | 70 | 205 | 205 | 597 | 183 | 277 |

| | Treatment | Negative Potential Magnetization Treatment (5 W) | | | | | | | | |
|---|---|---|---|---|---|---|---|---|---|---|
| Exhaust | Environment | Humidity 15% Temperature 2 C. | | | | | | | | |
| Emissions | RPM | 500 | | 1000 | | 1500 | | 2000 | | 2500 |
| Test No. | | 1 | 2 | 1 | 2 | 1 | 2 | 1 | 2 | 1 |
| CO | % | — | 0.01 | 0.43 | 0.28 | 0.66 | 0.21 | 0.75 | 0.07 | 0.61 |
| HC | ppm | — | 64 | 66 | 101 | 288 | 78 | 237 | 54 | 206 |
| CO2 | % | — | 15.4 | 14.5 | 15.4 | 14.2 | 15.4 | 14.4 | 15.4 | 14.5 |
| O2 | % | — | — | 1.08 | 0.34 | 1.19 | 0.23 | 0.96 | 0.3 | 0.81 |
| NO | ppm | — | 54 | 185 | 142 | 305 | 129 | 633 | 133 | 446 |

TABLE 8
Test Result of a HONDA Legend using premium gasoline (96)

| | Treatment | No-Treatment | | | | | | | | |
|---|---|---|---|---|---|---|---|---|---|---|
| Exhaust | Environment | Humidity 15% Temperature 2 C. | | | | | | | | |
| Emissions | RPM | 500 | | 1000 | | 1500 | | 2000 | | 2500 |
| Test No. | | 1 | 2 | 1 | 2 | 1 | 2 | 1 | 2 | 1 |
| CO | % | 0.18 | — | 0.94 | — | 0.65 | — | 0.61 | — | 0.19 |
| HC | ppm | 167 | — | 274 | — | 99 | — | 53 | — | 47 |
| CO2 | % | 15.3 | — | 14.9 | — | 15.3 | — | 15.4 | — | 15.9 |
| O2 | % | 1.11 | — | 1.11 | — | 0.82 | — | 0.65 | — | 0.23 |
| NO | ppm | 46 | — | 69 | — | 112 | — | 169 | — | 37 |
| | Treatment | Negative Potential Magnetization Treatment (5 W) | | | | | | | | |
| Exhaust | Environment | Humidity 15% Temperature 2 C. | | | | | | | | |
| Emissions | RPM | 500 | | 1000 | | 1500 | | 2000 | | 2500 |
| Test No. | | 1 | 2 | 1 | 2 | 1 | 2 | 1 | 2 | 1 |
| CO | % | 0.4 | — | 0 | — | 0 | — | 0 | — | −0.01 |
| HC | ppm | 57 | — | −0.1 | — | −0.1 | — | −0.1 | — | −0.1 |
| CO2 | % | 15.1 | — | 15.5 | — | 15.5 | — | 15.5 | — | 15.5 |
| O2 | % | 0.3 | — | 0.11 | — | 0.1 | — | 0.1 | — | 0.1 |
| NO | ppm | 5 | — | 0 | — | 1 | — | 2 | — | 4 |

Compared with the results of table 2˜5 it is found that the test results in table-6˜8 were not ideal! Obviously the humidity (moisture) affected the electromagnetic process effects to the air and the fuel. The reason may be because the percentage of the water molecules in the air and the fuel was too low. This reduced the Negative potential carriers in the Air/Fuel mixtures treated by the invention system. The lack of the Negative Potentials in the combustion chamber could not perform enough Potential Repulsions between the molecules and the cylinder inner wall. The inventor is still tracking test, especially the various vehicles and ships of the mainland China. Many efforts are being continued to achieve the stable and constant Energy saving and emission cut performance.

### Embodiment-3

See FIG. 10, it is a cross section of an Air filter housing of a motor car. In a engine system shown in FIG. 1, FIG. 10 was the cross section of the Air Filter (10) that supply clean air to the engine (7). We installed an Ag-coated stainless steel honeycomb-mesh (12) on the air filter element (11), the Ag-mesh could be installed upper or lower of filter element. This metal mesh (12) is also the Ag-mesh used in table-9, table-10 (referred as ‘Ag-mesh). An additional structure of this metal mesh could be a reticular structure module, and bind ceramic balls array (so-called ‘Ion Techno Ball’, with 5 mm diameter, made by Furuya Research) between 2 layers of stainless steel mesh. The density of the ceramics balls array is every 10 mm×10 mm. This metal mesh with ceramic balls were used in the test of Table 9, table 10 (referred ‘Ceramic-mesh’). During the tests, we used the Generator Unit (3) to output special AC currents to Electromagnetic Coil (2b). This coil (2b) could be installed on the metal-mesh by winding wires or be put on the meta-mesh. The output power of the current to the coil (2b) was 1 Watt. The output AC currents could be
(1) AC current with a single frequency
(2) mixture of AC currents that have different single frequencies
(3) AC current(s) with time-variation frequency.

In order to compare the data, we tested different vehicles models under the following test conditions, and got the Output power-Torque graphs (see FIG. 11˜15) to analysis the test results. The test results that obtained the maximum torque and maximum horsepower data are summarized in table-9 and table-10. Table-9 is the data of FIG. 11˜13, the transmission gear was 4^{th}. And the data in table-10 are FIG. 14˜15 with using 3^{rd} gear.

Test Conditions and Equipment:
Fuel: Toyota Caldina wagon (Regular gasoline engine) using regular Japanese gasoline (#90).
   Toyota Aristo Sedan (Premium gasoline engine) but used regular Japanese gasoline (#90).
Torque/Output tester: Chassis dynamometer DynaPack5000 (DynaPack made).
All the tests have been done strictly followed the procedures of DynaPack technical instructions content.
Names of the tests:
(1) Original No-Treatment=did not install any special mesh (12) in air filter (10), did not provide any magnetic treatments to the air
(2) Ag-mesh or Ceramic-mesh=Installed the ‘metal net silver’ (or Ceramic-mesh) (12) in the air filter (10). Installed the electromagnetic coil (2b) on the Air supply pipe (1b) or metal-mesh. When the coil provide electromagnetic field to the air, called “Magnetic treatment”. When the coil did not provide electromagnetic field to the air, called “No-treatment”.
(3) Only installed the electromagnetic coil (2b) on the Air supply pipe (1b), provide electromagnetic field to the air, also called “Magnetic treatment”.

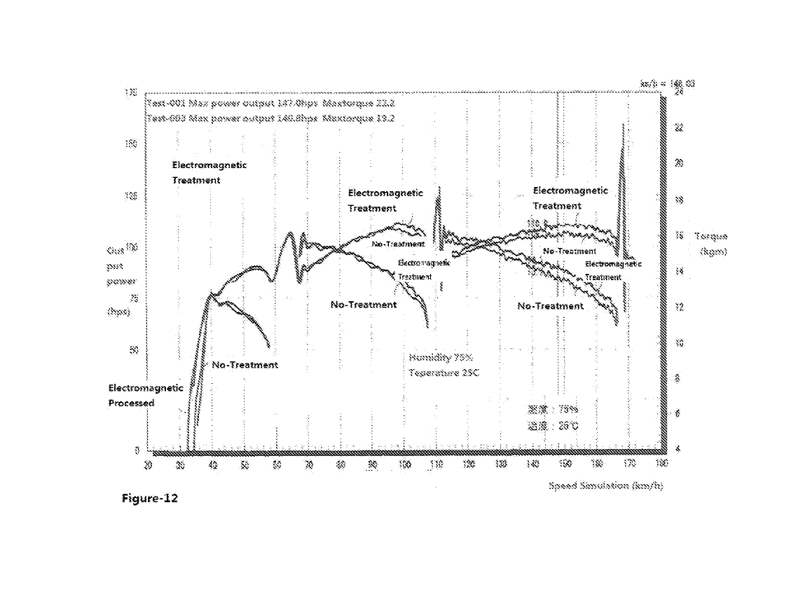

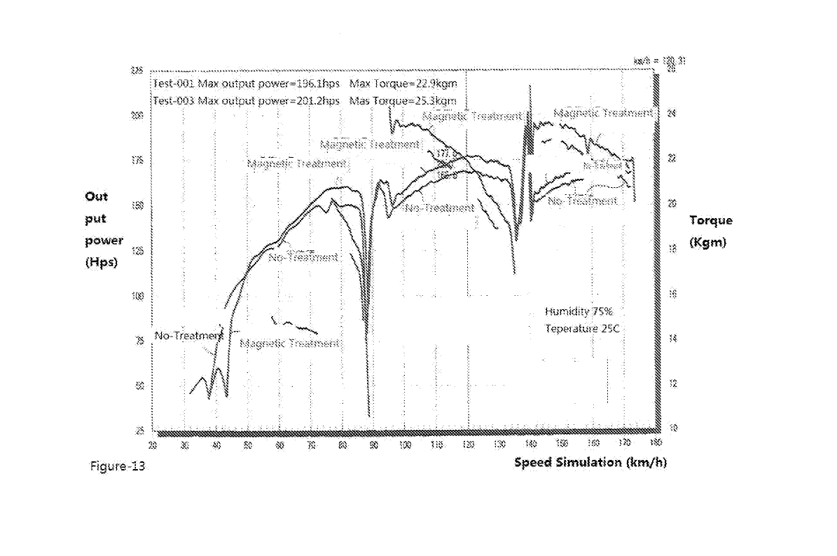

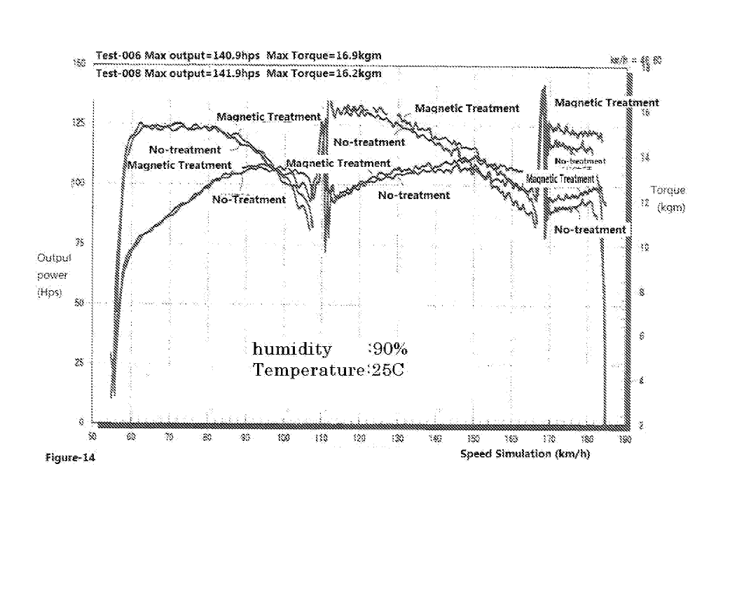

TABLE 9
Explanation of the power-torque profile in FIGS. 11~13(Toyota Caldina & Aristo)

| | | Treatment Type | | | | | | | |
|---|---|---|---|---|---|---|---|---|---|
| | | | | | | electromagnetic process | | | |
| | | | | | | | | Fuel Process | |
| | | No-Treatment | | | | | | Coil + Ag | |
| | | | | Ag coated mesh | | Only Process | | coated Mesh | |
| | | Standard | | in Air filter | | Air with Coil | | in Air filter | |
| | | Humidity 85%, | | Humidity 85%, | | Humidity 85%, | | Humidity 85%, | |
| Car | Test | Temperature | | Temperature | | Temperature | | Temperature | |
| Model | subjects | 16° C. | | 16° C. | | 16° C. | | 16° C. | |
| TOYOTA | Torque | FIG. 11 | 16.6 | FIG. 11 | 16.9 | FIG. 12 | 19.2 | FIG. 12 | 22.2 |
| CALDINA | (kg-m) | | | | | | | | |
| | Power | | 145.7 | | 140.8 | | 141.0 | | 147.0 |
| | (Hps) | | | | | | | | |
| TOYOTA | Torque | | — | FIG. 13 | 22.9 | | | FIG. 13 | 25.3 |
| Aristo | (kg-m) | | | | | | | | |
| | Power | | — | | 196.1 | | | | 201.2 |
| | (Hps) | | | | | | | | |

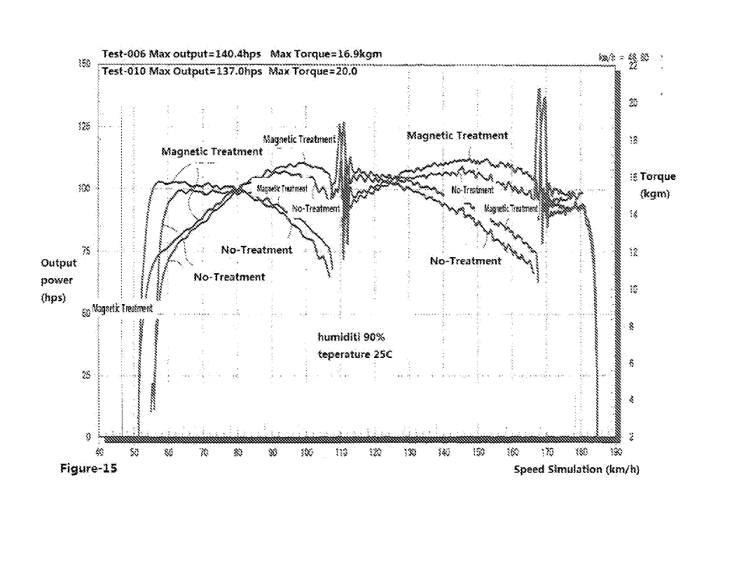

TABLE 10
Explanation of the power-torque profile
in FIGS. 14~15 (Toyota Caldina 3rd gear)

| | | Treatment Type | | | | | |
|---|---|---|---|---|---|---|---|
| | | | | electromagnetic process | | | |
| | | | | | | Fuel Process | |
| | | | | | | Coil + Ag | |
| | | No-Treatment | | Only Process | | coated Mesh | |
| | | Standard | | Air with Coil | | in Air filter | |
| | | Humidity 90%, | | Humidity 90%, | | Humidity 90%, | |
| Car | Test | Temperature | | Temperature | | Temperature | |
| Model | subjects | 25° C. | | 25° C. | | 25° C. | |
| Toyota | Torque | FIG. 14 | 16.6 | FIG. 14 | 16.2 | — | — |
| Caldina | (kg-m) | | | | | | |
| | Power | | 145.7 | | 141.9 | | — |
| | (Hps) | | | | | | |
| | Torque | FIG. 15 | 16.9 | — | — | FIG. 15 | 20.0 |
| | (kg-m) | | | | | | |
| | Power | | 140.4) | — | — | | 137.0 |
| | (Hps) | | | | | | |

The power-Torque profile in FIG. 11 is the test result of a TOYOTA CALDINA touring Wagon. The test conditions were:
Did not provide any additional equipment or treatments to the care, and kept the car in its original condition (No-Treatment).
Installed a Sliver (Ag) coated metal mesh into the air filter housing of that supplied the cleaned air to the engine. No electromagnetic coil module was used (Ag-mesh treatment).
The results show, only used the Ag-coated metal mesh to process the air supplies, the engine's maximum output power and torque performance did have obvious changes or basically as same as the No-treatment condition.

The power curve in FIG. 12 shows the Ag-mesh (12) was mounted on the air filter (10) of the Toyota Caldina Wagon, compared with the “without Mesh, only with magnetic treatment to the air (No-treatment)”, the “with Mesh and with magnetic treatment to air(Treated)” to the air have increased the Power output and Torque output in a wide RPM range, all performances were higher that of the “No-treatment” condition.

See FIG. 13, it was the test results of TOYOTA Aristo. It was the comparison of “Only use Ag-mesh in the air filter but did not use magnetic treatment(No Treatment)” and “Both used Ag-mesh and magnetic treatment(Treated)”. The graphs shown that the “Magnetic Treatment” did have largely improved the Engine's Power output and Torque output performances.

See FIG. 14, it was the test results comparison of Toyota Caldina wagon. It compared the “Do not install Ag-mesh (12) in the air filter (10), do not provide magnetic treatment to the air(No-treatment)” and “Do not install Ag-mesh (12) in Air filter (10), but provide Electro-Magnetic Treatment with the invention system(Treated)”. The results show that, although the maximum torque (peak) and maximum horsepower (peak) is very close, but the scope of all the speed in the peak outside, this invention could increase the engine's output torque and horsepower output higher than the ‘No-Treated’. The invention process could improve the engine performances.

See FIG. 15, it was the comparison of test results of Toyota Caldina wagon. “Do not install Ag-mesh (12) in Air filter (10)/do not provide Magnetic Treatment to the air (No-treatment)” versus “Installed Ag-mesh (12) in the air filter (10) and used Electromagnetic Coil to provide magnetic process to the air (Treated)” The results shows that in all speed range, the “Treated” have improved the engine's output power and Torque output. The maximum torque (peak) of the “Treated” is greater than the “No-treatment”, while the maxim um power of the “Treated” is very close or less than the “No-treatment” When using the Magnetic Processing system according to this invention in combination with some kinds of Catalysts, we would achieve better engine performance improvement.

As the data shown in FIG. 11˜15 and table-9˜10, we can make a conclusion that with using the Generators Unit (3) (has circuit in FIG. 3-1 and FIG. 3-2) of this invention to generator special AC currents to the Electromagnetic Coils (2a, 2b) to provide the Magnetic Treatments to the fuels and air that being supplied to the Engines (7), could improve the engine power performance (Output Power and Torque) with the same fuel consumption. And install some kinds of Air-processing Catalysts to assist the coil 2b, could make the treatment more efficient. The properties of the AC Currents that this invention uses for electromagnetic treatment are:
1. AC current that have Frequency Band Range from 4 KHz-24 KHz.
2. Types of AC currents:
2-1 AC current with a single frequency;
2-2 Mixture of AC currents with different single frequencies
2-3 AC current(s) with time-variation frequency.

### USAGE OF THIS INVENTION IN THE INDUSTRIES

By using the Invention's Electromagnetic Treatments to the liquid fuel (Gasoline, Diesel Fuel, Alcohol fuels, Liquefied natural gas, LPG) could change the Phase Boundary Potential (Or ZETA Potential) of fuels from Positive (+) to Negative (−)! This technology could increase the fuel's complete combustion ratios significantly in an engine (internal, external combustion engine and gas turbines). By using this invention system could improve the engine's output performances with the same fuel consumption ratio as before, and could also save the fuel consumption while keep the engine to run the same condition. This invention system could save the energies and reduce the Greenhouse gas and the harmful emissions released by combusting organic fuels (carbon hydrogen, nitrogen oxides, carbon monoxide, sulfur dioxide and carbon particles) due to incomplete combustion of the fuel and produce, effectively prevent air pollution and public nuisance disease.

1.-9. (canceled)

10. A fuel magnetization treatment method comprising:
installing at least one electromagnetic coil on a supply system supplying fuels to an engine combustion device, and connecting two electrodes of the coil to an electromagnet generator, and
providing an alternating current (AC) to the coil with the electromagnet generator, so that the coils produce alternate a magnetic field, by which the fuel to be delivered to the engine is magnetized; wherein the band of the AC is 4 KHz˜25 KHz,
wherein the supply system comprises a fuel tank, a fuel supply tubing, an air supply tubing, and an air filter, the fuel tank being connected with the combustion device via the fuel supply tubing, and the air filter being connected with the combustion device via the air supply tubing, and
wherein the coil is winded into a volute-shaped coil, attached to an insulator and then applied with a ceramic layer, so that a coil module is formed; the coil module can be installed in the fuel tank, in the air filter, on the periphery of the fuel supply tubing or the periphery of the air supply tubing, or installed in combination of any way above.

11. The fuel magnetization treatment method according to claim 10, wherein the AC is a current having a single frequency.

12. The fuel magnetization treatment method according to claim 10, wherein the AC is a single current simultaneously mixture of currents each having different single frequencies.

13. The fuel magnetization treatment method according to claim 10, wherein the AC is one or more currents each having a time-variation frequency.

14. The fuel magnetization treatment method according to claim 10, wherein the engine includes gasoline engines, diesel engines, heavy oil engines, and gas turbine.

15. The fuel magnetization treatment method according to claim 10, further comprising installing catalyst mesh in the air filter.

16. The fuel magnetization treatment method according to claim 10, wherein the catalyst mesh comprises an Ag-Mesh.
